(19) United States
(12) Patent Application Publication
(10) Pub. No.: US 2026/0319842 A1
(43) Pub. Date: Oct. 15, 2026

(54) NEURAL PROCESSING SoC AND PERFORMANCE MONITORING METHOD THEREOF

(71) Applicant: Rebellions Inc., Seongnam-si (KR)

(72) Inventors: Boeui Hong, Seongnam-si (KR); Hyunseok Ko, Seongnam-si (KR); Soobong Huh, Seongnam-si (KR); Jiun Yu, Seongnam-si (KR); Hyebin Jeong, Seongnam-si (KR); Sangjun Nam, Seongnam-si (KR); Jaedon Lee, Seongnam-si (KR)

(21) Appl. No.: 19/566,877

(22) Filed: Mar. 13, 2026

(30) Foreign Application Priority Data
Apr. 15, 2025 (KR) 10-2025-0048924

(51) Int. Cl. G06F 9/50

(52) U.S. Cl. CPC G06F 9/5016

(57) ABSTRACT

According to one or more embodiments of the present disclosure, a Neural Processing SoC may include a memory, a performance monitoring unit configured to monitor an operation of a target device to generate profiling data and store the profiling data in a first memory space of the memory, and a command processor configured to re-organize the profiling data to generate re-organized profiling data and store the re-organized profiling data in a second memory space of the memory.

### CROSS-REFERENCE TO RELATED APPLICATION

This application is based on and claims the benefit of priority to Korean Patent Application No. 10-2025-0048924, filed Apr. 15, 2025, the aforementioned priority application being hereby incorporated by reference in its entirety.

### TECHNICAL FIELD

The present disclosure relates to a Neural Processing System on a Chip (SoC) and a performance monitoring method thereof, and more particularly, to a Neural Processing SoC and a performance monitoring method thereof capable of increasing monitoring efficiency by re-organizing profiling data.

### BACKGROUND

With the recent development of artificial intelligence technology, a neural network accelerator, which is dedicated hardware for processing neural network-based operations at high speed, is being applied to various devices and services. A representative example of a neural network accelerator is a Neural Processing Unit (NPU). The neural network accelerator is optimized to process large-scale operations occurring during training and inference of deep learning models in parallel, and is capable of processing a large amount of data at high speed.

The neural network accelerator includes various components (e.g., a neural cluster, a DMA, a memory controller, etc.). Since the operations of these components affect the overall system performance, technology for monitoring the operation state of each component in real-time is becoming important. This enables bottleneck analysis, resource optimization, error diagnosis, and the like of the system.

Such monitoring should be designed so as not to affect the original computational tasks. The occurrence of events in the components within the neural network accelerator is non-deterministic, and when monitoring data of multiple components needs to be stored simultaneously, the size of the required memory space cannot be determined in advance. This may result in inefficient memory space allocation or excessive waste of storage space. In addition, since each component generates data in a different format, there is a difficulty in maintaining consistency in data integration and analysis. Therefore, there is a need for a performance monitoring method capable of re-organizing event-based operation monitoring data into a consistent format and optimizing storage space.

### SUMMARY

An object of the present disclosure is to provide a Neural Processing SoC and a performance monitoring method thereof, in which a command processor is involved in the generation and re-organization of profiling data, thereby generating profiling data inside the Neural Processing SoC in a more consistent format and efficiently managing the same.

An object of the present disclosure is to provide a Neural Processing SoC and a performance monitoring method thereof, in which a command processor re-organizes profiling data and stores the same in a minimized form, thereby improving memory space efficiency and making storage space requirements predictable.

The technical problems to be solved by the present disclosure are not limited to the technical problems mentioned above, and various technical problems not mentioned may be inferred by those skilled in the art from the present disclosure.

According to one or more embodiments of the present disclosure, a Neural Processing SoC may include a memory, a performance monitoring unit configured to monitor an operation of a target device to generate profiling data, and store the profiling data in a first memory space of the memory, and a command processor configured to re-organize the profiling data to generate re-organized profiling data, and store the re-organized profiling data in a second memory space of the memory.

In an embodiment, the command processor may be configured to determine a target device to be monitored among a plurality of devices based on a common Performance Monitoring Unit (PMU) query description provided from a host.

In an embodiment, the command processor may be configured to activate a performance monitoring unit of the target device to be monitored.

In an embodiment, the command processor may be configured to parse a common PMU query description provided from a host, predict a size of the profiling data based on the parsed common PMU query description, and pre-allocate the first memory space based on the predicted size of the data.

In an embodiment, the command processor may be configured to initialize the profiling data stored in the first memory space after storing the re-organized profiling data in the second memory space.

In an embodiment, the performance monitoring unit may be configured to generate the profiling data whenever one inference operation is finished, and the command processor may be configured to re-organize the generated profiling data to generate the re-organized profiling data whenever the one inference operation is finished.

In an embodiment, the command processor may be configured to receive, from a host, a command of one or more first command IDs and a command of a second command ID subsequent to the one or more first command IDs, parse a common PMU query description provided from the host, determine a size of the re-organized profiling data to be generated for each target device type based on the parsed common PMU query description, calculate a size of the re-organized profiling data to be generated according to the command of the one or more first command IDs based on the size of the re-organized profiling data to be generated for each target device type, generate a data offset for the second command ID based on the calculated size of the data, generate a data offset table including the data offset for the second command ID, and find re-organized profiling data corresponding to the second command ID in the second memory space based on the data offset table.

In an embodiment, the profiling data may include a command ID and timestamps of a plurality of events that sequentially occurred in the target device according to a command of the command ID, and the command processor may be configured to generate the re-organized profiling data by removing the command ID from the profiling data, recording difference values between the timestamps of the plurality of events, and converting a timestamp of an event, among the plurality of events, at which the operation of the target device according to the command of the command ID is finished, from a clock domain of the target device to a clock domain of the command processor, and recording the converted timestamp.

In an embodiment, the plurality of events may include a Queue-in and a Queue-out of the command of the command ID, and a task start and a task completion according to the command, and the recording the difference values between the timestamps of the plurality of events may include recording a difference value between timestamps of the Queue-out and Queue-in as a Queue time, recording a difference value between timestamps of the task start and the Queue-out as a pre-time, and recording a difference value between timestamps of the task completion and the task start as a run-time.

According to one or more embodiments of the present disclosure, a Neural Processing SoC may include a memory, a first performance monitoring unit configured to monitor an activity of a first neural core to generate first profiling data, and store the first profiling data in a first memory space of the memory, a second performance monitoring unit configured to monitor an activity of a second neural core to generate second profiling data, and store the second profiling data in a second memory space of the memory, and a command processor configured to re-organize the first profiling data and the second profiling data to generate re-organized profiling data, and store the re-organized profiling data in a third memory space of the memory.

In an embodiment, the command processor may generate re-organized profiling data by re-organizing the first profiling data and the second profiling data in a selected manner according to characteristics of operations executed by the first neural core and the second neural core.

In an embodiment, the command processor may be configured to generate the re-organized profiling data based on an average value of a run-time of the first neural core and a run-time of the second neural core, in a case where the first neural core and the second neural core perform evenly distributed operations.

In an embodiment, the command processor may be configured to generate the re-organized profiling data based on a run-time of the first neural core, in a case where the first neural core performs operations intensively.

In an embodiment, the command processor may be configured to calculate a time difference of the second profiling data of the second neural core with respect to the first profiling data of the first neural core, and generate the re-organized profiling data based on the time difference.

According to one or more embodiments of the present disclosure, a performance monitoring method of a Neural Processing SoC performed by a command processor may include receiving a common PMU query description from a host, determining a target device to be monitored by parsing the common PMU query description activating a performance monitoring unit for monitoring an activity of the target device, and generating re-organized profiling data based on profiling data generated by the performance monitoring unit.

In an embodiment, the method may further include initializing a memory space of a memory in which the profiling data generated by the performance monitoring unit is stored.

According to embodiments of the present disclosure, a command processor is involved in the generation and re-organization of profiling data, thereby generating profiling data inside the Neural Processing SoC in a more consistent format and efficiently managing the same.

According to embodiments of the present disclosure, a command processor re-organizes profiling data and stores the same in a minimized form, thereby improving memory space efficiency and making storage space requirements predictable.

### BRIEF DESCRIPTION OF THE DRAWINGS

Embodiments will be more clearly understood from the following detailed description taken in conjunction with the accompanying drawings in which:

FIG. 1 is a diagram for explaining a neural processing system according to embodiments of the present disclosure.

FIG. 2 is a diagram for explaining the Neural Processing SoC of FIG. 1 in detail.

FIG. 3 is a diagram for explaining the neural cluster of FIG. 2 in detail.

FIG. 4 is a diagram for explaining the neural core of FIG. 3 in detail.

FIG. 5 is a block diagram for explaining an overview of operations of components performing a performance monitoring method according to embodiments of the present disclosure.

FIG. 6 is a flowchart for explaining a performance monitoring method according to embodiments of the present disclosure in detail.

FIG. 7 is a diagram for explaining the common PMU query description of FIG. 6.

FIG. 8 is a diagram for explaining main operations of a command processor in the performance monitoring method of FIG. 6 in detail.

FIG. 9 is a diagram for explaining a method of re-organizing profiling data of a DMA by a command processor according to embodiments of the present disclosure.

FIGS. 10 and 11 are diagrams for explaining a data offset table.

FIG. 12 is a diagram for explaining a method of re-organizing profiling data of a neural core by a command processor according to embodiments of the present disclosure.

FIG. 13 is a diagram for explaining an embodiment of the method of monitoring the neural core of FIG. 12.

FIG. 14 is a diagram for explaining another embodiment of the method of monitoring the neural core of FIG. 12.

FIG. 15 is a diagram for explaining yet another embodiment of the method of monitoring the neural core of FIG. 12.

FIG. 16 is a diagram for explaining a method of monitoring a device performing a scatter-gather operation by a command processor according to embodiments of the present disclosure.

FIG. 17 is a diagram for explaining a method of monitoring two devices performing data transmission by a command processor according to embodiments of the present disclosure.

FIG. 18 is a diagram for explaining a deep learning operation performed by a neural processing system according to embodiments of the present disclosure.

FIG. 19 is a diagram for explaining training and inference operations of an artificial neural network in a neural processing system according to embodiments of the present invention.

### DETAILED DESCRIPTION

Hereinafter, specific embodiments of the present disclosure will be described in detail with reference to the accompanying drawings. In the present specification, specific descriptions of well-known functions or configurations are omitted when there is a concern that they may unnecessarily complicate or obscure the essence of the present disclosure.

The advantages, features, and achieving methods of the disclosed embodiments will be clearly understood by referring to the accompanying drawings and the embodiments described later. However, the present disclosure is not limited to these embodiments and can be implemented in various forms. These embodiments are examples provided to help the overall understanding of the present disclosure and are not intended to limit the scope of the present disclosure.

In the accompanying drawings, identical or similar components are given identical reference numerals. In addition, when describing embodiments of the present disclosure, descriptions of identical or similar components may be omitted to avoid duplicate descriptions. However, this omission of description is not intended to mean that the corresponding component is not included in a particular embodiment.

The terms used in this specification fully reflect the functions of the invention and have been selected from terms currently generally used in the art, but these may vary depending on the views of those skilled in the relevant field or new technological developments. In addition, in specific cases, there may be terms arbitrarily selected by the applicant, and in this case, their meaning will be described in detail in the specification. Therefore, the terms in this specification should be interpreted based on their meaning and the overall context of the present disclosure, rather than merely as names.

When a term is expressed in the singular in this specification, it may also include a plural meaning unless explicitly limited to the singular. Conversely, when expressed in the plural, it may be interpreted as singular in context unless explicitly limited to plural. Throughout the specification, when a specific part is said to include a certain component, this means that additional components may be included, rather than excluding other components.

In this specification, the expression “each of a plurality of A” or “a plurality of A each” may refer to each of all elements included in a plurality of A, or may refer to each of some elements of a plurality of A.

In this specification, the expression “one or more A” or “at least one A” may mean a set of one or more of A unless clearly expressed otherwise in context.

The expressions “may include,” “may be provided with,” “may have,” etc., used in this specification mean the existence of a corresponding feature (e.g., function, operation, or component, etc.) and do not exclude the existence of additional other features. That is, these expressions should be understood as open-ended terms that allow for the inclusion of other embodiments.

The expression “configured to” as used herein may have meanings such as “set to,” “having the capability to,” “modified to,” “made to,” or “able to,” depending on the context. This expression is not limited to “specifically designed in hardware,” and for example, a processor configured to perform a specific operation may be a general-purpose processor capable of performing the operation through software execution, or a special-purpose computer structured through programming to perform the specific operation.

The terms “connect,” “transmit,” “send,” “receive,” etc., used in this specification may mean direct connection, transmission, and reception between components, or may mean indirect connection, transmission, and reception with other components interposed therebetween.

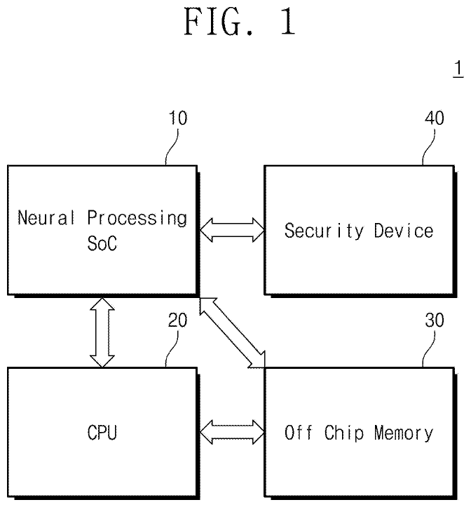

FIG. 1 is a diagram for explaining a neural processing system according to embodiments of the present disclosure.

A neural processing system 1 according to embodiments of the present disclosure may include a Neural Processing System on a Chip (SoC) 10, a Central Processing Unit (CPU) 20, an off-chip memory 30, and a security device 40.

The Neural Processing SoC 10 may be configured in the form of a system-on-chip and may be a device specialized for operations of an artificial neural network model. The Neural Processing SoC 10 may be an artificial neural network accelerator. The Neural Processing SoC 10 may communicate with the CPU 20, the off-chip memory 30, and the security device 40 to perform operations such as computations.

The CPU 20 may be a general-purpose operation processor. The CPU 20 may not be suitable for neural network operations of deep learning. Therefore, the CPU 20 may request neural network operations to the neural processing SoC 10. That is, the CPU 20 may be a host that gives instructions to the Neural Processing SoC 10. The CPU 20 may send a command stream to the Neural Processing SoC 10 to instruct neural network operations. The CPU 20 may receive a result of the neural network operation from the Neural Processing SoC 10. The CPU 20 may be connected to the off-chip memory 30.

In the present disclosure, a command stream may be a set of commands for controlling the workflow of the entire system. The command stream is composed of several commands and may define the execution order of each task and the flow of work according to the commands. For example, the command stream may control the entire workflow such as data loading, operation execution, and result storage. A task is a unit of work constituting the command stream and may be performed to achieve a specific purpose. The task may include operations such as matrix multiplication and convolution operations. Some of the tasks may trigger the execution of an instruction set. Instructions may include basic operation units such as reading data from memory, performing operations, and writing data to memory.

The off-chip memory 30 may be a memory chip located outside the chip, distinct from the Neural Processing SoC 10 and the CPU 20. The off-chip memory 30 may include a non-volatile memory and a volatile memory.

For example, the non-volatile memory may include Read Only Memory (ROM), Electrically Erasable Programmable Read-Only Memory (EEPROM), flash memory, Magnetic RAM (MRAM), spin-transfer torque MRAM, Conductive bridging RAM (CBRAM), Ferroelectric RAM (FeRAM), Phase change RAM (PRAM), etc., but the present disclosure is not limited thereto. For example, the volatile memory may include Dynamic random access memory (DRAM), Static random access memory (SRAM), Synchronous Dynamic Random Access Memory (SDRAM), etc., but the present disclosure is not limited thereto.

The off-chip memory 30 may be configured in various forms such as a single chip, a memory module, a memory card, a chip in which memories are stacked, a chiplet including a memory, etc., but the present disclosure is not limited thereto.

The security device 40 may be a device that supports security and debugging functions such as secure boot firmware.

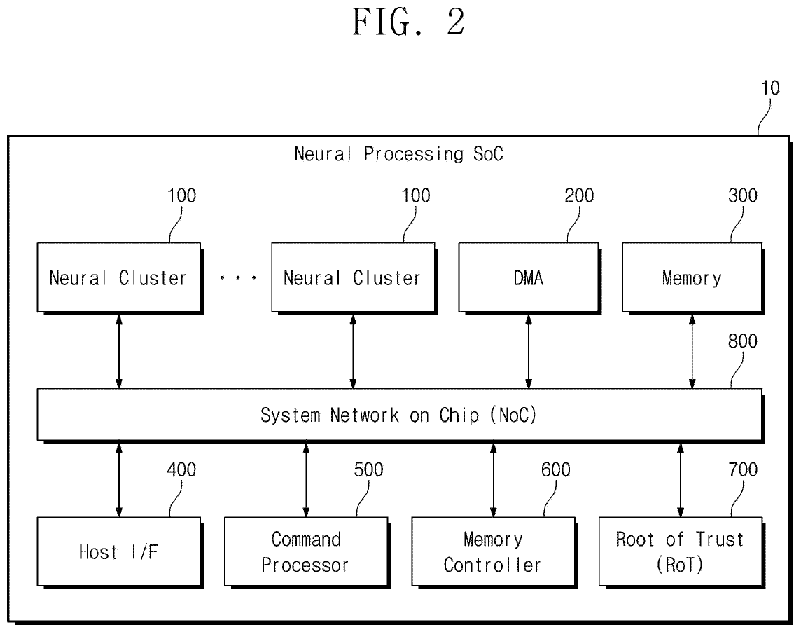

FIG. 2 is a diagram for explaining the Neural Processing SoC of FIG. 1 in detail.

The Neural Processing SoC 10 according to embodiments of the present disclosure may include a neural cluster 100, a Direct Memory Access (DMA) 200, a memory 300, a host interface 400, a command processor 500, a memory controller 600, a Root of Trust (RoT) 700, and a System Network on Chip (NoC) 800. The DMA 200, the host interface 400, the memory controller 600, and the RoT 700 may be implemented as a circuit or circuitry, respectively.

The neural cluster 100 may be a device that processes neural network operations. The neural cluster 100 may be connected to the DMA 200, the memory 300, the host interface 400, the command processor 500, the memory controller 600, and the RoT 700 through the System NoC 800. Also, the neural cluster 100 may be connected to another neural cluster 100 through the System NoC 800. Although two neural clusters 100 are illustrated in FIG. 2, the present disclosure is not limited thereto. That is, the Neural Processing SoC 10 may include three or more neural clusters 100 or may include one neural cluster 100. Also, each neural cluster 100 may be the same or similar processor, or may be a heterogeneous processor.

The DMA 200 may directly transmit data between memory and peripheral devices without the intervention of the neural cluster 100 or the CPU 20 connected through the host interface 400. The DMA 200 may minimize interrupts of processors such as the CPU 20 and the neural cluster 100 and support parallel processing tasks to improve system performance. For example, the DMA 200 may control data movement between memories 300, data movement between the memory 300 and the external off-chip memory 30, data movement within the off-chip memory 30, and the like.

The memory 300 may be shared by a plurality of neural clusters 100. Also, the memory 300 may be shared by other components of the Neural Processing SoC 10 other than the neural cluster 100. That is, the memory 300 may operate as a global memory. The memory 300 may store data received from the off-chip memory 30. The neural cluster 100 may perform neural network operations based on the data stored in the memory 300. The neural cluster 100 may store neural network operation results and the like in the memory 300. Data stored in the memory 300 may be moved to the off-chip memory 30 by control of the DMA 200 or the like. For example, the memory 300 may store input data, weights, task information, intermediate operation results, operation results, and the like.

For example, the memory 300 may be a memory having a relatively fast access speed, such as SRAM. However, this is exemplary, and the memory 300 may include various memories such as DRAM, and the present disclosure is not limited thereto.

In an embodiment, the memory 300 may be disposed as an off-chip memory in the Neural Processing SoC 10 as a separate component. In this case, the memory 300 may correspond to an L2 cache memory. In another embodiment, the memory 300 may be configured as a memory inside the neural cluster 100. In this case, the memory 300 may correspond to an L1 cache memory. The memory 300 may operate as a global memory regardless of the configuration form.

The host interface 400 may perform communication between the Neural Processing SoC 10 and the CPU 20. Through the host interface 400, the Neural Processing SoC 10 may receive a command stream from the CPU 20 and transmit operation results and status information of the Neural Processing SoC 10 to the CPU 20.

For example, the host interface 400 may perform communication based on communication protocols such as Peripheral Component Interconnect express (PCIe), Serial Peripheral Interconnect (SPI), Universal Serial Bus (USB), Mobile Industry Processor Interface (MIPI), Mobile Display Digital Interface (MDDI), Mobile Video Interface (MVI), Serial Advanced Technology Attachment express (SATAe), etc. However, this is exemplary, and the present disclosure is not limited thereto.

The command processor 500 may receive a command stream from the CPU 20 through the host interface 400. The command processor 500 may generate one or more tasks based on the received command stream and transmit them to the neural cluster 100 and the DMA 200. The DMA 200 may read data required for task execution (e.g., weights, input data, etc.) from the memory 300, or read from the off-chip memory 30 in cooperation with the memory controller 600, and transmit the data to the neural cluster 100. The neural cluster 100 may perform neural network operations based on the received tasks and data, and transmit a task progress status (e.g., a completion signal, etc.) to the command processor 500. The command processor 500 may receive a data transmission status, a task progress status, and the like from the DMA 200 and the neural cluster 100.

The memory controller 600 may be connected to the off-chip memory 30. In case where the off-chip memory 30 includes a volatile memory, the memory controller 600 may include a volatile memory controller for controlling operations of the volatile memory such as data reading and writing, and refresh. In case where the off-chip memory 30 includes a non-volatile memory, the memory controller 600 may include a non-volatile memory controller for controlling operations of the non-volatile memory such as data reading and writing, and wear leveling. The memory controller 600 may perform control operations for the off-chip memory 30 through commands from, for example, the neural cluster 100, the DMA 200, and the command processor 500.

The RoT 700 is responsible for the security of the Neural Processing SoC 10 and may perform tasks such as secure boot, firmware integrity check, and system integrity maintenance during execution. The RoT 700 may communicate with the external security device 40 to perform security procedures.

The System NoC 800 may connect the neural cluster 100, the DMA 200, the memory 300, the host interface 400, the command processor 500, the memory controller 600, and the RoT 700 to each other. Through the System NoC 800, data or control signals may be exchanged between the neural cluster 100, the DMA 200, the memory 300, the host interface 400, the command processor 500, the memory controller 600, and the RoT 700. Also, through the System NoC 800, synchronization signals for controlling synchronization between neural clusters 100 may be exchanged between the neural clusters 100.

For example, the System NoC 800 may be configured in various forms such as a multi-layer architecture, a bus-based network structure, a ring structure, etc., but the present disclosure is not limited thereto.

Neural network operations of the Neural Processing SoC 10 may be performed through the following process. First, the CPU 20 may transmit a command stream for neural network operations to the Neural Processing SoC 10. The command processor 500 may generate one or more tasks based on the received command stream and transmit them to the neural cluster 100 and the DMA 200. Simultaneously or sequentially, operation-related data such as weights and input data of the neural network for neural network operations may move from the off-chip memory 30 to the memory 300 of the Neural Processing SoC 10. The movement of data may be performed by a memory controller of the CPU 20 under the control of the CPU 20, or may be performed by the memory controller 600 of the Neural Processing SoC 10 under the control of the DMA 200 of the Neural Processing SoC 10. The neural cluster 100 of the Neural Processing SoC 10 may perform neural network operations based on input data, weights, tasks, and the like. The operation result may be stored in the memory 300 of the Neural Processing SoC 10 or the off-chip memory 30. The CPU 20 may read the operation result from the memory 300 or the off-chip memory 30.

Meanwhile, the Neural Processing SoC 10 may monitor operations of internal components by the request of the CPU 20 during the neural network operation process. The Neural Processing SoC 10 may determine a target device to be monitored among the components according to the request of the CPU 20. The Neural Processing SoC 10 may monitor the target device to generate profiling data analyzing the operation of the target device based on events on a time axis. Since the structure and operation of the target devices are different, the operation of the target device may be recorded in the profiling data in different formats and units depending on the target device.

The command processor 500 according to embodiments of the present disclosure may be involved in the generation and re-organization process of profiling data. The command processor 500 may receive a common PMU (Performance Monitoring Unit) query description from the CPU 20. The common PMU query description is a standardized query method that queries profiling data regarding various events occurring in a performance monitoring unit 10000 included in a target device within the Neural Processing SoC 10, which will be described later, in a common format regardless of the type or state of the target device, thereby enabling collection and analysis of profiling data in a consistent manner from various target devices.

The command processor 500 may determine a target device to be monitored and a target data type based on the common PMU query description. Also, the command processor 500 may re-organize the profiling data based on the common PMU query description to generate re-organized profiling data optimized in size in a consistent format. Therefore, the Neural Processing SoC 10 may store monitoring results in an optimized form to improve storage space and search efficiency, and may provide monitoring results in a consistent format to the CPU 20 even if the structure or version of the components inside the Neural Processing SoC 10 changes.

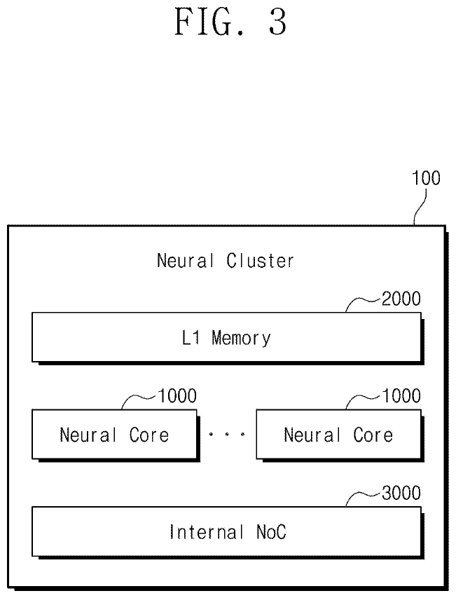

FIG. 3 is a diagram for explaining the neural cluster of FIG. 2 in detail.

The neural cluster 100 according to embodiments of the present disclosure may include a neural core 1000, an L1 memory 2000, and an internal NoC 3000. The neural core 1000 may be implemented as a circuit or circuitry.

The neural cluster 100 may include a plurality of neural cores 1000. The neural core 1000 may be configured to process neural network operations. The neural core 1000 may receive a task and perform work according to the task. The neural core 1000 may transmit a task execution completion signal to the command processor 500 through the internal NoC 3000.

Although two neural cores 1000 are illustrated in FIG. 3, the neural cluster 100 may include three or more neural cores 1000 or may include one neural core 1000, and the present disclosure is not limited thereto.

The L1 memory 2000 may be shared by a plurality of neural cores 1000. The L1 memory 2000 may also be shared by other components of the Neural Processing SoC 10 other than the corresponding neural cluster 100, for example, a plurality of neural cores 1000 of another neural cluster 100.

The L1 memory 2000 may store data received from the off-chip memory 30. The neural cluster 100 may perform neural network operations based on data stored in the L1 memory 2000. Data stored in the L1 memory 2000 may be moved to the off-chip memory 30 by control of the DMA 200 or the like. For example, the L1 memory 2000 may store input data, weights, task information, intermediate operation results, operation results, and the like.

In an embodiment, the L1 memory 2000 may be an on-chip memory located inside the neural cluster 100. The L1 memory 2000 may replace the off-chip type memory 300 located outside the neural cluster 100, and in this case, the memory 300 may be omitted. Alternatively, the L1 memory 2000 may operate as a separate global memory apart from the off-chip type memory 300.

In an embodiment, the L1 memory 2000 may be an off-chip memory disposed outside the neural cluster 100. That is, the L1 memory 2000 may be a memory corresponding to the memory 300.

The internal NoC 3000 may connect the plurality of neural cores 1000 and the L1 memory 2000 to each other. For example, the internal NoC 3000 may be configured in various forms such as a multi-layer architecture, a bus-based network structure, a ring structure, a mesh network, etc., but the present disclosure is not limited thereto.

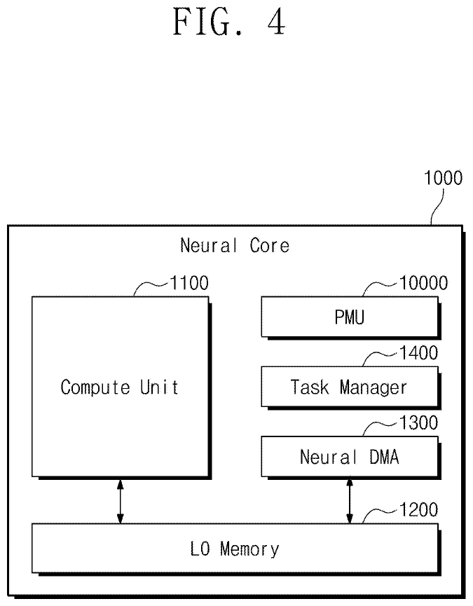

FIG. 4 is a diagram for explaining the neural core of FIG. 3 in detail.

The neural core 1000 may include a compute unit 1100, an LO memory 1200, a neural DMA 1300, a task manager 1400, and a performance monitoring unit 10000. The compute unit 1100, the neural DMA 1300, the task manager 1400, and the performance monitoring unit 10000 may each be implemented as a circuit or circuitry.

The compute unit 1100 can perform various computation tasks. The compute unit 1100 can combine SIMD (Single Instruction Multiple Data) operation elements and MIMD (Multiple Instruction Multiple Data) operation elements. SIMD is suitable for repeatedly applying the same operation to a plurality of data by processing a plurality of data elements simultaneously with a single instruction, while MIMD utilizes instruction-level parallelism by executing different instructions simultaneously to process different data. The compute unit 1100 can optimize parallel performance and instruction-level dependency control in various operation scenarios by combining SIMD and MIMD operation elements.

The compute unit 1100 may be connected to the L0 memory 1200. The compute unit 1100 uses the L0 memory 1200 as a cache memory and can write data such as intermediate calculation results to the L0 memory 1200 or read necessary data (e.g., input data, operation instructions, weights, etc.) from the L0 memory 1200 during the operation process. Input data may be operation target data read from an external memory (e.g., L0 memory 1200, memory 300, etc.) to the LO memory 1200. Intermediate calculation results may be data generated by the compute unit 1100 during operation and stored in the L0 memory 1200. In addition, the compute unit 1100 can perform operations based on operation instructions stored in the L0 memory 1200, and can accelerate operation speed by caching data frequently used in the operations in the L0 memory 1200.

The L0 memory 1200 may be connected to the compute unit 1100 and the neural DMA 1300. The L0 memory 1200 can operate as a cache memory that stores data or instructions necessary for the operations of the compute unit 1100 and the neural DMA 1300. For example, the L0 memory 1200 may be SRAM, but it may be various other types of memory in addition to SRAM, and the present disclosure is not limited thereto.

The neural DMA 1300 may be connected to the L0 memory 1200. The neural DMA 1300 may manage data transfer between the L0 memory 1200 and the L1 memory 2000.

The task manager 1400 may operate with the command processor 500 to maximize the utilization of the operational resources of each neural core 1000. The task manager 1400 can manage task queues of the neural cores 1000, synchronization of the neural cores 1000, task priorities, or the like. The task manager 1400 can control synchronization between the neural cores 1000. Through this, tasks distributed by the command processor 500 can be performed simultaneously among the neural cores 1000.

The performance monitoring unit 10000 is a device included in a specific device and configured to monitor information related to performance during the operation of the device and record the same in memory. The performance monitoring unit 10000 may monitor the operation of the neural core 1000 to generate profiling data. Although not shown, the performance monitoring unit 10000 may include a plurality of counters for monitoring individual operation types such as data input, operation, and output of the neural core 1000. The performance monitoring unit 10000 may generate profiling data based on counter values received from the counters. The performance monitoring unit 10000 may be configured to store profiling data in a designated memory space of the memory 300 or the L1 memory 2000. The address and size of the memory space may be determined by the command processor 500. The performance monitoring unit 10000 may exist individually in each of the plurality of neural cores 1000.

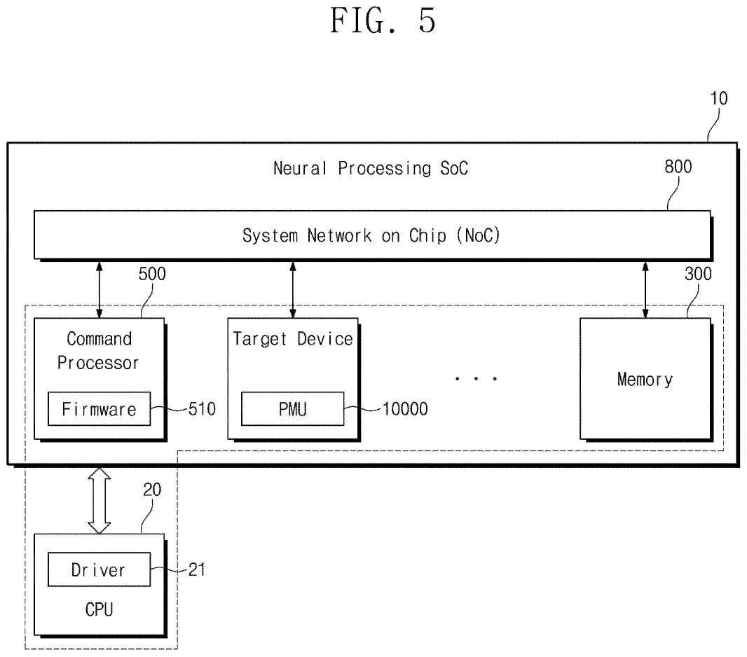

FIG. 5 is a block diagram for explaining an overview of operations of components performing a performance monitoring method according to embodiments of the present disclosure.

Referring to FIG. 5, the CPU 20 may include a driver 21. The driver 21 may include a kernel driver and a user driver. The kernel driver is a driver executed in the kernel space of the operating system of the CPU 20, and the CPU 20 may communicate with the host interface 400 of the Neural Processing SoC 10 through the kernel driver. The user driver is a driver executed in the user space of the operating system of the CPU 20, and the CPU 20 may provide an Application Programming Interface (API) necessary for the user through the user driver.

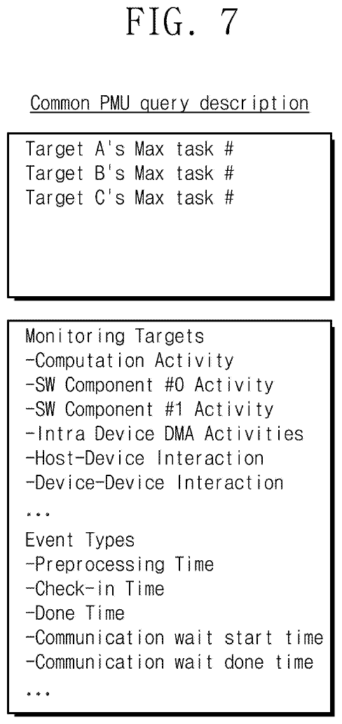

The CPU 20 according to embodiments of the present disclosure may provide an API for a performance monitoring query to a user. The user may determine a monitoring target and an event type to be monitored through the API. The monitoring target may include a specific operation or a target device. The CPU 20 may receive a common PMU query description in a consistent format regardless of the type or state of the target device from the user through the API. The common PMU query description is described in detail with reference to FIG. 7.

The command processor 500 may include firmware 510. The command processor 500 may interact with the performance monitoring unit 10000 of the target device and the memory 300 through the firmware 510 to perform the performance monitoring method according to embodiments of the present disclosure.

The command processor 500 may determine at least one of a target device to be monitored among a plurality of devices or a target data type based on the common PMU query description received through the host interface 400. The target device may include at least one of all components of the Neural Processing SoC 10 including the neural cluster 100, the DMA 200, the memory 300, the host interface 400, the command processor 500, the memory controller 600, and the RoT 700.

The command processor 500 may activate the performance monitoring unit 10000 of the target device to be monitored among the plurality of target devices. There may be one or more target devices to be monitored. Therefore, one or more performance monitoring units 10000 may be activated. The command processor 500 may re-organize profiling data generated in the target device to generate re-organized profiling data. The command processor 500 may store the re-organized profiling data in a second memory space of the memory 300. The command processor 500 may provide the re-organized profiling data to the CPU 20 as a monitoring result. Since the command processor 500 generates profiling data based on the common PMU query description of a consistent format and re-organizes the profiling data to generate re-organized profiling data, monitoring results can be provided to the user in a consistent format.

The command processor 500 may set a first memory space of the memory 300 where profiling data will be stored and a second memory space of the memory 300 where re-organized profiling data will be stored. The command processor 500 may be configured to initialize the profiling data stored in the first memory space after storing the re-organized profiling data in the second memory space.

The performance monitoring unit 10000 may be configured to monitor the operation of the target device under the control of the command processor 500 to generate profiling data, and store the profiling data in the first memory space of the memory 300. The performance monitoring unit 10000 may be independently included in each target device. For example, the performance monitoring unit 10000 may exist for each neural core 1000. One or more performance monitoring units 10000 may exist for each target device. The operation of the device monitored by the performance monitoring unit 10000 and the format and unit of the profiling data generated may vary depending on the characteristics of the target device.

The memory 300 may store the profiling data generated in the performance monitoring unit 10000 of the target device in the first memory space. The memory 300 may transmit the stored profiling data to the command processor 500 by the request of the command processor 500. The memory 300 may store the re-organized profiling data generated in the command processor 500 in the second memory space. The memory 300 may transmit the stored re-organized profiling data to the command processor 500 or the CPU 20 according to the request of the command processor 500.

The performance monitoring method performed by the CPU 20, the command processor 500, the performance monitoring unit 10000, and the memory 300 according to embodiments of the present disclosure will be described in detail below.

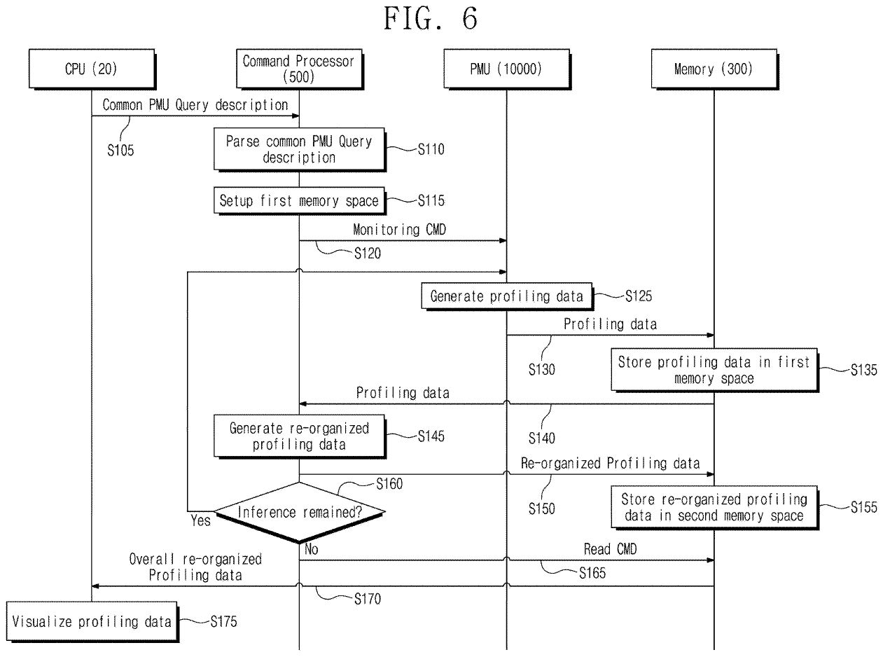

FIG. 6 is a flowchart for explaining a performance monitoring method according to embodiments of the present disclosure in detail.

In FIG. 6, a process of monitoring a task execution operation of a language processing series among neural network operations is described as an example. Language processing may be performed in units of words. In the present disclosure, a process in which each word is processed is referred to as inference. For example, in a language processing process for the purpose of translation, if an input sentence consists of n words and an output sentence consists of m words, the Neural Processing SoC 10 may process ntm inferences. Hereinafter, a process of monitoring an operation of translating one sentence by the Neural Processing SoC 10 will be described.

First, the CPU 20 may transmit a common PMU query description to the command processor 500 through the host interface 400 (S105). The CPU 20 may transmit the common PMU query description provided from the user through the API to the command processor 500. Also, the CPU 20 may transmit a command stream for processing ntm inferences to the Neural Processing SoC 10. The command processor 500 may receive the common PMU query description and the command stream. Regardless of the monitoring process, the command processor 500 may generate one or more tasks based on the received command stream and transmit them to the components of the Neural Processing SoC 10.

The command processor 500 may parse the received common PMU query description (S110). The reception and parsing of the common PMU query description may be performed once in the entire process of monitoring the ntm inference operations of the Neural Processing SoC 10. The command processor 500 may parse the common PMU query description to determine at least one of a target device to be monitored among the plurality of devices of the Neural Processing SoC 10 and a target data type.

The command processor 500 may set a first memory space of the memory 300 based on the parsed common PMU query description (S115).

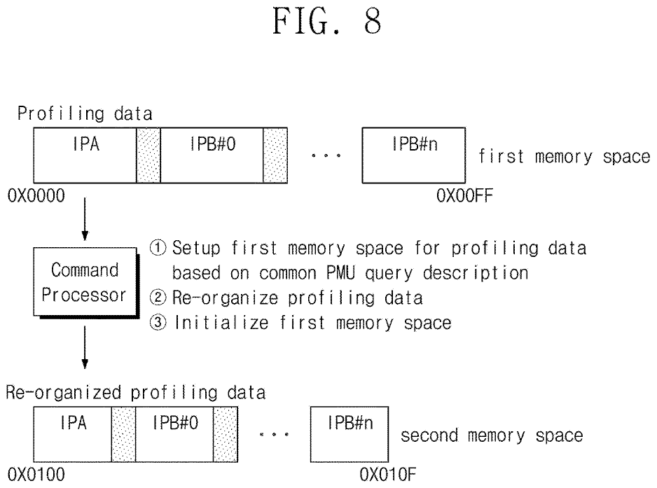

Specifically, the command processor 500 may be configured to predict a size of the profiling data based on the parsed common PMU query description, and pre-allocate the first memory space based on the predicted size of the data. A specific method of predicting the size of profiling data based on the common PMU query description will be described with reference to FIG. 8.

The command processor 500 may also predict a size of the re-organized profiling data based on the parsed common PMU query description, and pre-allocate a second memory space based on the predicted size of the data.

The command processor 500 may transmit a monitoring command to the determined target device (S120). The command processor 500 may activate the performance monitoring unit 10000 of the target device through the monitoring command. There may be one or more determined target devices, and in case where there are a plurality of target devices, the command processor 500 may transmit a monitoring command to each of the target devices.

The command processor 500 may generate an address corresponding to the first memory space and transmit it to the performance monitoring unit 10000 together with the monitoring command.

The performance monitoring unit 10000 may monitor the operation of the target device for processing one inference to generate profiling data (S125). For example, in the case of monitoring the operation of the neural core 1000 for one inference, processes such as the neural core 1000 receiving a task from the command processor 500, receiving weights and data for operation from the L1 memory 2000, performing operation according to the task, and transmitting a task execution completion signal to the command processor 500 may be recorded and generated as profiling data.

Then, the performance monitoring unit 10000 may transmit the generated profiling data to the memory 300 (S130). The performance monitoring unit 10000 may transmit an address corresponding to the first memory space provided from the command processor 500 and a write command to the memory 300 together with the profiling data. The memory 300 may receive the address and the write command.

The memory 300 may store the profiling data in the first memory space (S135). Also, the memory 300 may transmit the profiling data stored in the first memory space to the command processor 500 by the request of the command processor 500 (S140).

The command processor 500 may re-organize the profiling data to generate re-organized profiling data (S145). The size of the generated re-organized profiling data may be equal to or smaller than the profiling data.

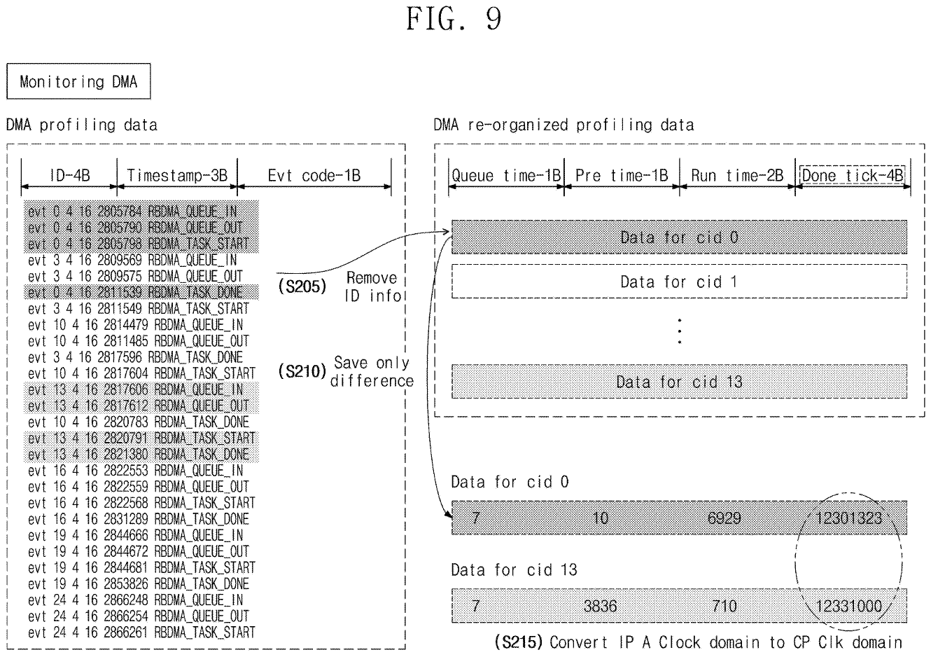

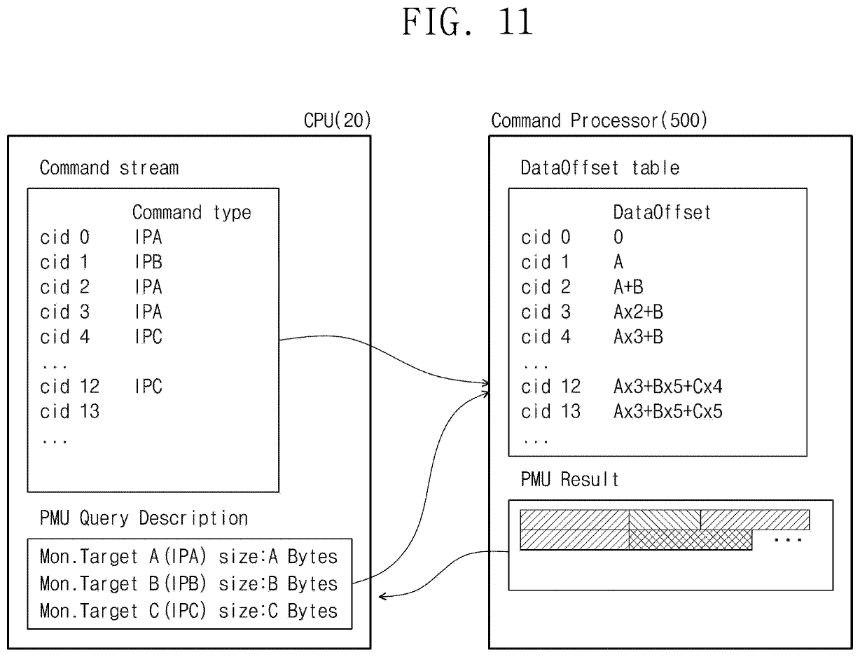

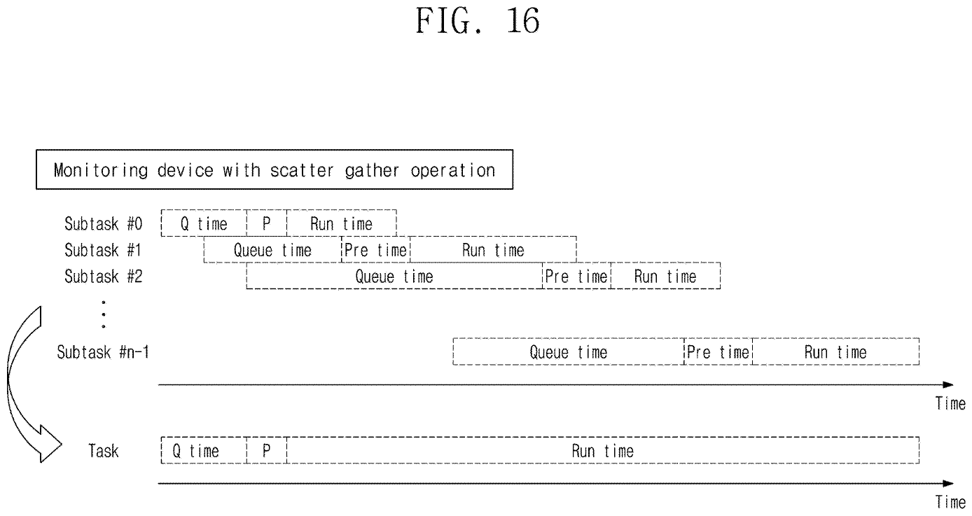

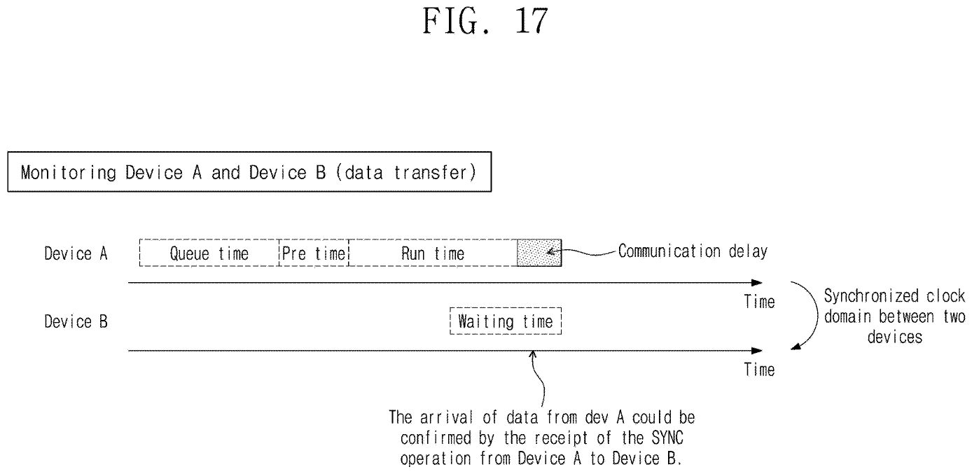

The command processor 500 may generate re-organized profiling data in different ways depending on the type and operation characteristics of the target device. A method of generating re-organized profiling data based on profiling data of the DMA 200 is explained with reference to FIGS. 9 to 11, and a method of generating re-organized profiling data based on profiling data of a plurality of neural cores 1000 is explained with reference to FIGS. 12 to 15. Also, methods of generating re-organized profiling data based on profiling data of a device performing a scatter-gather operation and two devices performing data transmission are explained with reference to FIGS. 16 and 17, respectively.

The command processor 500 may transmit the generated re-organized profiling data to the memory 300 (S150). The command processor 500 may transmit an address corresponding to the second memory space and a write command to the memory 300 together with the re-organized profiling data.

The memory 300 may store the re-organized profiling data in the second memory space (S155).

The monitoring and data re-organization operations by the command processor 500 do not affect the inference operation. Inference may consist of an inference operation of the neural cluster 100 and incidental processing operations performed in the firmware 510 of the command processor 500. The monitoring and data re-organization operations may consist of a section in which the performance monitoring unit 10000 monitors the operation of the target device (e.g., neural cluster 100) to generate profiling data, and a section in which the firmware 510 of the command processor 500 generates re-organized profiling data based thereon. Compared to the case where monitoring is not performed, the overall processing time of the neural cluster 100 and the command processor 500 may increase due to the added monitoring and data re-organization operations. However, since the sections of each operation do not affect each other's operations, the processing time of the inference process may remain the same regardless of whether monitoring is performed.

Then, the command processor 500 may determine whether there is any remaining inference (S160). That is, the command processor 500 may determine whether all ntm inference operations have been performed.

If there is remaining inference to be performed (Yes direction), the performance monitoring unit 10000 may monitor the activity of the target device for processing the next one inference operation to generate profiling data (S125). If there is no remaining inference to be performed (No direction), that is, if all ntm inference operations have been performed, the command processor 500 performs the next operation.

Steps S125 to S160 explained above may be repeatedly performed for every n+m inferences. In sum, the performance monitoring unit 10000 may be configured to generate profiling data whenever one inference operation is finished, and the command processor 500 may be configured to re-organize the generated profiling data to generate re-organized profiling data whenever one inference operation is finished.

Although not shown in FIG. 6, the command processor 500 may be configured to initialize the profiling data stored in the first memory space of the memory 300 after storing the re-organized profiling data in the second memory space of the memory 300. The command processor 500 may initialize the first memory space whenever one inference operation is finished, or initialize the first memory space after all inferences are finished.

Then, the command processor 500 may transmit a request for reading the entire re-organized profiling data to the memory 300 (S165). The command processor 500 may transmit an address corresponding to the second memory space to the memory 300 together with a read command.

The memory 300 may transmit the stored entire re-organized profiling data to the CPU 20 according to the read command of the command processor 500 (S170). As another example, the memory 300 may transmit the entire re-organized profiling data to the command processor 500 according to the read command, and the command processor 500 may transmit the received entire re-organized profiling data to the CPU 20 again.

The CPU 20 may visualize the re-organized profiling data through an application and provide it to the user (S175). The user may monitor the operation of the target device through the visualized graph. The visualization application may vary, such as a commercially available program or a customized program, and the present disclosure is not limited thereto.

The command processor 500 according to embodiments of the present disclosure may receive and parse the common PMU query description from the CPU 20, and determine a target device to be monitored and a target data type based thereon. The command processor 500 may monitor the performance of the target device based on the common PMU query description in a consistent form, and provide monitoring results of events designated by the user as re-organized profiling data in a standardized format. Therefore, through the intervention of the command processor 500, the Neural Processing SoC 10 may provide monitoring results in a consistent format to the CPU 20 even if the version or structure of the internal component (target device) changes.

Also, since the command processor 500 according to embodiments of the present disclosure re-organizes profiling data and stores it in a minimized form, memory space efficiency is improved and the storage space size can be predicted in advance. Therefore, memory usage efficiency can be improved.

FIG. 7 is a diagram for explaining the common PMU query description of FIG. 6.

Referring to FIG. 7, the common PMU query description may include the maximum number of tasks per target device (Target A's Max task#, Target B's Max task#, Target C's Max task#), Monitoring Targets, and Event Types to be monitored.

The maximum number of tasks per target device may be provided by a compiler of the CPU 20. The command stream is composed of commands for instructing the execution of tasks to be performed by each target device. The compiler of the CPU 20 may analyze the command stream to generate the maximum number of tasks to be performed per target device. The CPU 20 may provide the maximum number of tasks to be performed per target device to the command processor 500 through the common PMU query description.

The monitoring target and the event type to be monitored may be provided by the user. The user may input the monitoring target and the event type through the API for performance monitoring query provided by the CPU 20. The CPU 20 may generate event type information and the monitoring target in a consistent format through the API.

For example, the monitoring target may include computation activity, activities of software components, DMA activity, interaction between host and device, interaction between devices, and the like. For example, the event type may include pre-processing time, check-in time, completion time, communication wait start and end time, and the like. However, the above-described monitoring targets and event types are exemplary, and various other monitoring targets and event types may be provided as the common PMU query description, and the present disclosure is not limited thereto.

FIG. 8 is a diagram for explaining main operations of a command processor in the performance monitoring method of FIG. 6 in detail.

Referring to FIG. 8, the command processor 500 may predict the size of profiling data based on the common PMU query description, and set a first memory space of the memory 300 for storing the profiling data based thereon.

Specifically, the command processor 500 may obtain the maximum number of tasks per target device from the common PMU query description. The command processor 500 may obtain the memory requirement per command of the performance monitoring unit 10000 for each target device from the target device. The command processor 500 may use a value obtained by multiplying the maximum number of tasks per target device by the memory requirement per command of the performance monitoring unit 10000 of the corresponding target device as a predicted value of the profiling data size to be generated from the target device. The command processor 500 may secure a memory space equal to or larger than the predicted value as the first memory space in the memory 300.

In the example of FIG. 8, the first memory space is illustrated as including a memory space from address 0X0000 to 0X00FF of the memory 300. For example, data including profiling data of the operation of target device IPA, and profiling data of the 0th operation and the n-th operation of target device IPB may be stored in the first memory space. A padding space for distinguishing data may be added between profiling data. In FIG. 8, the padding space is indicated by a dot pattern.

The command processor 500 may re-organize the profiling data to generate re-organized profiling data. The command processor 500 may store the re-organized profiling data in a second memory space smaller than the first memory space. In the example of FIG. 8, the second memory space is illustrated as including a memory space from address 0X0100 to 0X010F of the memory 300. For example, data including re-organized profiling data of the target device IPA, and re-organized profiling data of the Oth operation and the n-th operation of the target device IPB may be stored in the second memory space. A padding space for distinguishing data may also be added between re-organized profiling data.

The first memory space may be a memory space distinct from the second memory space. For example, the start address of the second memory space may be continuous with or discontinuous from the end address of the first memory space. For example, the second memory space may be a memory space having a smaller size than the first memory space.

As described above, the command processor 500 may be configured to initialize the profiling data stored in the first memory space of the memory 300 after storing the re-organized profiling data in the second memory space of the memory 300.

The command processor 500 may be involved in the generation and re-organization of profiling data through the above-described operations.

The overview of performance monitoring method performed by the command processor 500 according to embodiments of the present disclosure has been explained above. Hereinafter, specific methods of generating re-organized profiling data for the operation of a target device according to the type and operation type of the target device will be explained.

FIG. 9 is a diagram for explaining a method of re-organizing profiling data of a DMA by a command processor according to embodiments of the present disclosure.

Referring to FIG. 9, profiling data of the DMA 200 generated by the performance monitoring unit 10000 of the DMA 200 is shown on the left. The profiling data of the DMA 200 may include a command ID, timestamps of a plurality of events that sequentially occurred in the DMA 200, which is the target device, according to the command of the command ID, and an event code indicating the event type. The plurality of events may include four events. The command ID information may be 4 bytes, the timestamp may be 3 bytes, and the event code may be 1 byte. In the example of FIG. 9, the profiling data may be 8 bytes per event, so the profiling data for four events occurring in association with one command ID may be a total of 32 bytes.

For example, for the same command ID “evt 0 4 16”, events of Queue-in (QUEUE_IN) and Queue-out (QUEUE_OUT) of the command of the corresponding command ID, and task start (TASK_START) and task completion (TASK_DONE) according to the command may occur in the DMA 200. Queue-in and Queue-out are an event in which a command is input to a queue of the DMA 200 and an event in which a command is output from the queue according to a predetermined rule, respectively. Task start and task completion are an event of starting a task in the DMA 200 according to a command output from the queue and an event of completing the task.

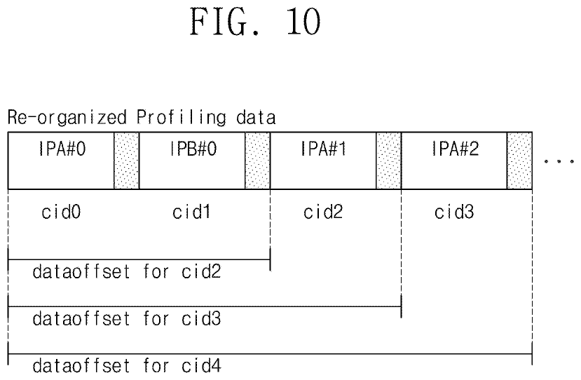

The command processor 500 may first remove the command ID from the profiling data of the DMA 200 (S205). By this, 4 bytes of data can be reduced from the profiling data. The command processor 500 may generate a data offset table to find re-organized profiling data corresponding to a specific command ID without the command ID. Data offset and the data offset table are explained with reference to FIGS. 10 and 11.

Next, the command processor 500 may record difference values between timestamps of the plurality of events (S210). Specifically, the command processor 500 may record a difference value between timestamps of Queue-out and Queue-in as a Queue time, record a difference value between timestamps of task start and Queue-out as a pre-time, and record a difference value between timestamps of task completion and task start as a run-time. Queue time is the time the command stayed in the queue, pre-time is the time until the task is actually started according to the command in the DMA 200 after the command is output from the queue, and run-time is data representing the actual time the DMA 200 performed the task.

The command processor 500 may generate re-organized profiling data by recording the Queue time, pre-time, and run-time in a row corresponding to one command ID.

Finally, the command processor 500 may convert the information recorded in the re-organized profiling data from the clock domain of the DMA 200 to the clock domain of the command processor 500 (S215).

Specifically, the command processor 500 may convert a timestamp of an event (e.g., task completion event), among the plurality of events, at which the operation of the DMA 200 according to the command of the command ID is finished, from the clock domain of the target device (e.g., DMA 200) to the clock domain of the command processor 500, and record the converted timestamp. For example, components of the Neural Processing SoC 10 may be configured to transmit a task execution completion signal to the command processor 500 at the time when the task is finished, and through this, the time when the operation of the DMA 200 is finished can be recorded in the clock domain of the command processor 500. The recorded time may be referred to as a done tick. The command processor 500 may additionally record the done tick in the re-organized profiling data of each command ID. The done tick may be 4 bytes.

Even if the clock domain serving as a reference for recording is different for each profiling data, the command processor 500 may determine the timestamps of events recorded in each re-organized profiling data as the same reference based on the done tick generated in one clock domain.

The generated re-organized profiling data may have a size of 8 bytes per each command ID. This is a result reduced by 75% compared to 32 bytes of profiling data for four events occurring for one command ID.

The configurations and sizes of the profiling data and re-organized profiling data explained above are exemplary, and profiling data and re-organized profiling data may be implemented with various configurations and sizes, and the present disclosure is not limited thereto.

FIGS. 10 and 11 are diagrams for explaining a data offset table.

As described above, the command processor 500 may remove the command ID from the profiling data of the DMA 200. Re-organized profiling data can be generated in a consistent format (structure, data size, etc.). The command processor 500 may calculate a data offset of each re-organized profiling data based on the size of the re-organized profiling data. Data offset means the difference from a reference address to data corresponding to each command ID within the re-organized profiling data. The command processor 500 can identify the location of re-organized profiling data corresponding to each command ID by calculating the data offset from the first address, even without the command ID.

Referring to FIG. 10, re-organized profiling data for the Oth operation of the target device IPA according to the command of cid0, the Oth operation of IPB according to the command of cid1, the 1st operation of IPA according to the command of cid2, and the 2nd operation of IPA according to the command of cid3 may be sequentially stored in the second memory space.

For example, the command processor 500 may record the size of the re-organized profiling data of cido and one padding space as the data offset for cid1. The command processor 500 may determine an address reflecting the data offset for cid1 to the first address as the start address of the re-organized profiling data of cid1. The command processor 500 may record the size of the re-organized profiling data of cid0 and cid1 and two padding spaces as the data offset for cid2. The command processor 500 may determine an address reflecting the data offset for cid2 to the first address as the start address of the re-organized profiling data of cid2. Similarly, the command processor 500 may record data offsets for cid3 and cid4, and based thereon, search for the locations of re-organized profiling data for cid3 and cid4 without command IDs.

The command processor 500 according to an embodiment of the present disclosure may generate a data offset table by calculating a data offset for each command ID, and search for re-organized profiling information based on the data offset table. The data offset table may be generated through the following process.

Referring to FIG. 11, the command processor 500 may be provided with a command stream from the CPU 20. For example, the command stream may include commands of consecutive command IDs from cid0 to cid13. The command of each command ID may have the same or different command type. For example, commands of cid0, cid2, and cid3 may have a command type of IPA where the execution device is A, cid1 may have a command type of IPB where the execution device is B, and cid4 and cid12 may have a command type of IPC where the execution device is C. Through the command type, the command processor 500 can identify the monitoring target device associated with each command ID.

The command processor 500 may be additionally provided with a common PMU query description from the CPU 20. In the example of FIG. 11, the common PMU query description may additionally include the size of re-organized profiling data to be generated for each target device type. Since re-organized profiling data is generated in a consistent format, the size of the re-organized profiling data can be predicted in advance. For example, the size of re-organized profiling data in case where the target device is A (Mon. Target A (IPA) size) may be A bytes, the size of re-organized profiling data in case where the target device is B (Mon. Target B (IPB) size) may be B bytes, and the size of re-organized profiling data in case where the target device is C (Mon. Target C (IPC) size) may be C bytes. The size of re-organized profiling data to be generated for each target device type may be generated by the compiler of the CPU 20 based on the command stream.

The command processor 500 may parse the common PMU query description and determine the size of re-organized profiling data to be generated for each target device type based on the parsed common PMU query description. The command processor 500 may generate a data offset table based on the size of re-organized profiling data to be generated for each target device type.

Specifically, the command processor 500 may receive one or more command IDs (e.g., first command IDs) and a command subsequent thereto (e.g., second command ID) from the CPU 20, and calculate the size of re-organized profiling data to be generated according to the command of the one or more first command IDs consecutively preceding the second command ID, based on the size of re-organized profiling data to be generated for each target device type. The command processor 500 may generate a data offset for the corresponding command ID (second command ID) based on the calculated size of the data, and generate a data offset table including the data offset for the corresponding command ID (second command ID). The command processor 500 may generate data offsets for all command IDs received after the second command ID and record them in the data offset table.

For example, since cid0 has no preceding command, the data offset may be recorded as 0. That is, the command processor 500 may determine data stored from the first address of the second memory space to an address after A bytes as re-organized profiling data corresponding to cid0. The command processor 500 may record the data size (A bytes) of command ID cid0 preceding cid1 as the data offset of cid1. That is, the command processor 500 may determine an address after A bytes and one padding space from the first address of the second memory space as the start address of the re-organized profiling data of cid1. The command processor 500 may record the data sizes (B bytes, A bytes) of command IDs cid1 and cid0 consecutively preceding cid2 and the size of two padding spaces as the data offset of cid2. That is, the command processor 500 may determine an address after A+B bytes and two padding spaces from the first address of the second memory space as the start address of the re-organized profiling data of cid2. Data offsets of command IDs cid3 to cid13 may also be calculated and recorded in the data offset table in the same manner.

The command processor 500 may store the data offset table in various memory spaces including an internal on-chip memory or a specific space of the memory 300 and use it, and the present disclosure is not limited thereto.

The command processor 500 may be configured to find re-organized profiling data corresponding to a specific command ID (e.g., second command ID) in the second memory space based on the data offset table recorded in the above-described manner.

Also, the command processor 500 may directly store re-organized profiling data corresponding to each command ID in each address based on the data offset table.

Hereinafter, a method of generating re-organized profiling data based on profiling data of a plurality of neural cores 1000 will be explained.

FIG. 12 is a diagram for explaining a method of re-organizing profiling data of a neural core by a command processor according to embodiments of the present disclosure.

Referring to FIG. 12, profiling data generated by the performance monitoring unit 10000 of a single neural core 1000 is shown on the left. The profiling data of the neural core 1000 may include a command ID, a Queue time, a pre-time, and a run-time. Queue time is the time the command stayed in the queue, pre-time is the time until the task actually is started according to the command in the neural core 1000 after the command is output from the queue, and run-time is data meaning the time the neural core 1000 actually performed the task. The command ID information may be 4 bytes, the Queue time may be 2 bytes, the pre-time may be 36 bits, and the run-time may be 44 bits. Therefore, profiling data generated in a single neural core 1000 for one command ID may be 16 bytes.

The command processor 500 according to embodiments of the present disclosure may add a done tick recorded in the clock domain of the command processor 500 to the profiling data. The done tick may be 8 bytes, and the total size of the processed profiling data may be 24 bytes. The command processor 500 may generate re-organized profiling data for a plurality of neural cores 1000 based on the processed profiling data.

The Neural Processing SoC 10 mainly performs parallel data processing, and a plurality of neural cores 1000 included in one or more neural clusters 100 may operate simultaneously to perform one job (e.g., dot product of an N×M matrix and an M×K size matrix). The performance monitoring unit 10000 of each neural core 1000 may generate a plurality of profiling data. Since the neural cores 1000 are designed symmetrically, a tendency can be derived among the plurality of profiling data. Therefore, the overall operation situation of the plurality of neural cores 1000 can be expressed using data having representativeness according to specific conditions among the plurality of profiling data. Using data having representativeness can effectively express the operation situation of the entire neural cores 1000 while reducing the overall size of re-organized profiling data.

The configurations and sizes of the profiling data and re-organized profiling data described above are exemplary, and profiling data and re-organized profiling data may be implemented with various configurations and sizes, and the present disclosure is not limited thereto.

The Neural Processing SoC 10 according to an embodiment of the present disclosure may include the following configurations. The Neural Processing SoC 10 may include a plurality of neural clusters 100. Each of the neural clusters 100 may include a plurality of neural cores 1000, for example, a first neural core and a second neural core. The Neural Processing SoC 10 may include a first performance monitoring unit configured to monitor an activity of the first neural core to generate first profiling data and store the first profiling data in a first memory space of the memory 300, and a second performance monitoring unit configured to monitor an activity of the second neural core to generate second profiling data and store the second profiling data in a second memory space of the memory 300. The command processor 500 may be configured to re-organize the first profiling data and the second profiling data to generate re-organized profiling data, and store the re-organized profiling data in a third memory space of the memory 300.

The command processor 500 according to an embodiment of the present disclosure may re-organize profiling data of a plurality of neural cores (e.g., first profiling data and second profiling data) in a selected manner according to characteristics of operations executed by the plurality of neural cores (e.g., first neural core and second neural core) to generate re-organized profiling data. Hereinafter, methods of monitoring the performance of neural cores according to characteristics of each operation will be described.

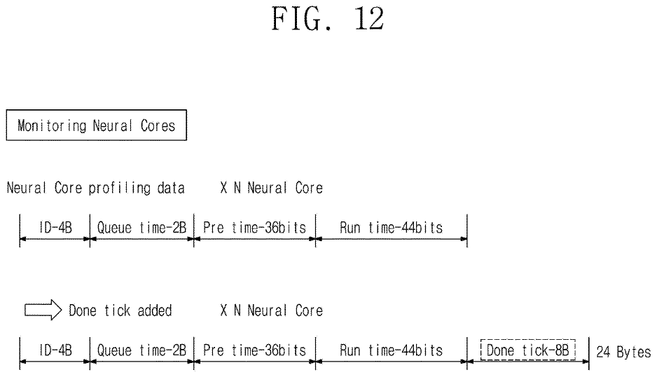

FIG. 13 is a diagram for explaining an embodiment of the method of monitoring the neural core of FIG. 12.

In FIG. 13, a case is illustrated in which the 0-th neural core to the (n-1)-th neural core perform evenly distributed operations. The end time of the entire operation may be the time when operations of all neural cores are finished. In FIG. 13, for convenience of explanation, only Queue time and run-time are shown for the profiling data of each neural core. The Queue times of the 0th neural core to the (n-1)-th neural core may vary depending on the situation of each queue. Since the neural cores are designed symmetrically, the run-times of the 0th neural core to the (n-1)-th neural core may be generally consistent.

In the present disclosure, the expression “evenly distributed” may be interpreted as a concept including not only strict mathematically even distribution but also substantially even distribution. For example, a case where the amount of operation assigned to individual neural cores has a deviation of about ±5% to ±10% compared to the average amount of operation may also be included in the even distribution of the present disclosure. However, the above-mentioned numerical range is exemplary and the present disclosure is not limited thereto.

In an embodiment, the command processor 500 may determine an average value of run-times of each of the 0th neural core to the (n-1)-th neural core as one data having representativeness, and generate re-organized profiling data based on the average value of run-times. Queue time, pre-time, and done tick, the Queue time, pre-time, and done tick of each of the Oth neural core to the (n-1)-th neural core may be used, or average values of Queue time, pre-time, and done tick may be used to generate re-organized profiling data.

In another embodiment, the command processor 500 may determine the time from the start time of the run-time of the neural core that starts operation earliest among the 0th neural core to the (n-1)-th neural core to the end time of the run-time of the neural core that finishes operation last as one data having representativeness. The command processor 500 may extract re-organized profiling data based thereon. Even in this case, Queue time, pre-time, and done tick, the Queue time, pre-time, and done tick of each of the 0th neural core to the (n-1)-th neural core may be used, or average values of Queue time, pre-time, and done tick may be used to generate re-organized profiling data.

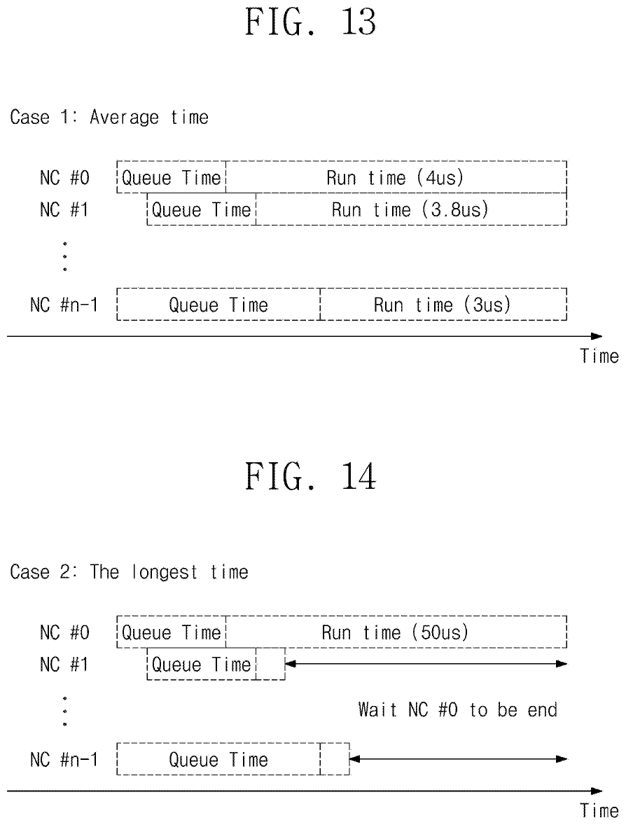

FIG. 14 is a diagram for explaining another embodiment of the method of monitoring the neural core of FIG. 12.

In FIG. 14, a case where one of the 0th neural core to the (n-1)-th neural core performs operations intensively is illustrated. In FIG. 14, for convenience of explanation, only Queue time and run-time are shown for the profiling data of each neural core.

In a situation where the Oth neural core performs operations intensively as in the example of FIG. 14, the 1st neural core to the (n-1)-th neural core may wait until the operation of the 0th neural core is finished. For example, the run-time of the 0th neural core may be 50 us, and the run-times of the 1st neural core to the (n-1)-th neural core may be significantly shorter times such as 3 us, 4 us, etc. In this case, since asymmetrical profiling data is generated in each neural core, the average value of run-times of the neural cores does not have representativeness.

The command processor 500 according to embodiments of the present disclosure may be configured to generate re-organized profiling data based on the run-time of the corresponding neural core in case where one of the plurality of neural cores performs operations intensively. In the example of FIG. 14, the command processor 500 may be configured to generate re-organized profiling data based on the run-time of the 0th neural core performing operations intensively among the Oth neural core to the (n-1)-th neural core. Queue time, pre-time, and done tick, the Queue time, pre-time, and done tick of each of the 0th neural core to the (n-1)-th neural core may be used, or average values of Queue time, pre-time, and done tick may be used to generate re-organized profiling data.

In the present specification, the expression “performs operations intensively” may be interpreted as a concept including a case where operations are not evenly distributed but are intensively allocated to a small number of neural cores to be performed. For example, a case where operations are performed with more than a specific numerical range (e.g., 90%) of the total operation amount allocated to a small number of neural cores may also correspond to this. However, the above-mentioned numerical range is exemplary and the present disclosure is not limited thereto.

For example, in the above-described situation, the command processor 500 may determine the neural core having the longest run-time among the plurality of neural cores as the neural core performing operations intensively.

In the examples of FIGS. 13 and 14, by generating re-organized profiling data based on one representative data, the data size can be reduced to approximately 1/n compared to the case of directly using n profiling data.

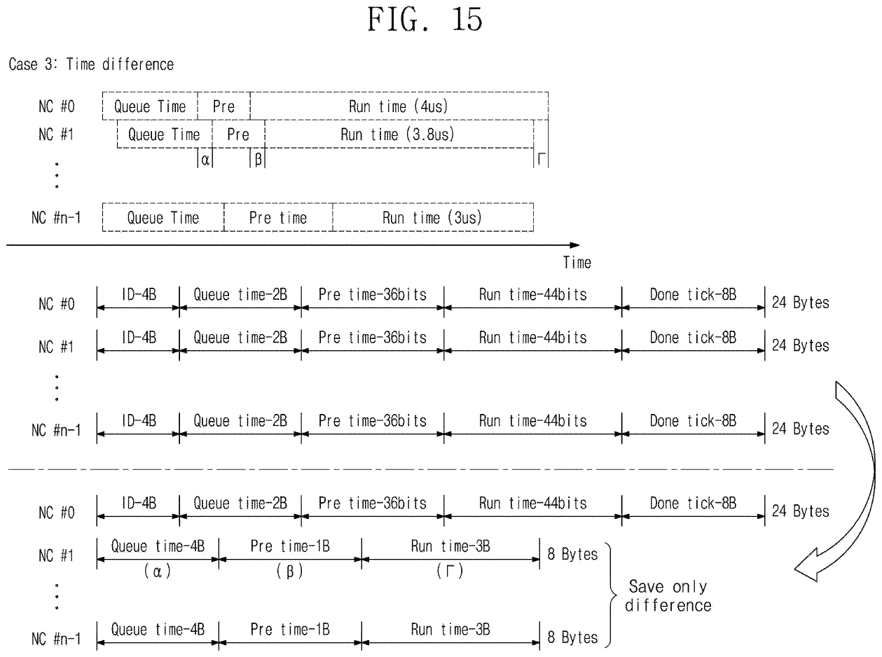

FIG. 15 is a diagram for explaining yet another embodiment of the method of monitoring the neural core of FIG. 12.

In FIG. 15, a case where it is difficult to extract data having representativeness from profiling data of a plurality of neural cores 1000 is illustrated. The command processor 500 according to embodiments of the present disclosure may be configured to calculate a time difference of profiling data of the remaining neural cores (e.g., second neural core) with respect to profiling data of one of the plurality of neural cores (e.g., first neural core among the first neural core and the second neural core) as a reference, and generate re-organized profiling data based on the time difference.

In the example of FIG. 15, the command processor 500 may determine profiling data of the Oth neural core (0th profiling data) as reference data. The Oth profiling data may include a command ID of 4 bytes, a Queue time of 2 bytes, a pre-time of 36 bits, a run-time of 44 bits, and a done tick of 8 bytes. The 0th profiling data may be used as re-organized profiling data as it is. Profiling data of the 1st neural core is compared with the Queue time, pre-time, and run-time of the 0th profiling data to calculate a time difference, and re-organized profiling data can be generated based on the calculated time difference. Similarly, profiling data of the 2nd neural core to the (n-1)-th neural core are also compared with the 0th profiling data to calculate respective time differences, and re-organized profiling data can be generated based on the time differences, respectively.

Since the 0th to (n-1)-th neural cores perform tasks (operations) according to commands of the same command ID, the command ID may be omitted except for re-organized profiling data for the 0th profiling data. Also, since a task execution completion signal is transmitted to the command processor 500 after all operations are completed in the 0th to (n-1)-th neural cores to generate a done tick, the done ticks of the 0th to (n-1)-th neural cores may be the same. Therefore, the done tick may also be omitted except for re-organized profiling data for the 0th profiling data.

The command processor 500 may determine any one of profiling data generated in the 1st to (n-1)-th neural cores as reference data, as well as the 0th profiling data generated in the 0th neural core, and the present disclosure is not limited thereto.

In the example of FIG. 15, by generating re-organized profiling data based on difference values from reference data, data storage space can be minimized compared to the case of directly using n profiling data.

Meanwhile, in case where a monitoring command for an event not provided by components (target devices) of the Neural Processing SoC 10 is received from the CPU 20, the command processor 500 may be configured to generate re-organized profiling data in an optimized manner. Some examples are described with reference to FIGS. 16 and 17.

FIG. 16 is a diagram for explaining a method of monitoring a device performing a scatter-gather operation by a command processor according to embodiments of the present disclosure.

The Neural Processing SoC 10 according to embodiments of the present disclosure may perform a scatter-gather operation based on a rule table. The scatter-gather operation is an operation in which one command transmitted from the CPU 20 is divided into a plurality of sub-tasks inside the Neural Processing SoC 10 and processed in parallel. For example, the scatter-gather operation may be performed in the DMA.

While a component (target device) performing sub-tasks within the Neural Processing SoC 10 generates profiling data for each sub-task, the CPU 20 recognizes it as a single task for one command, so the command processor 500 needs to re-organize the generated profiling data into one data.

Referring to FIG. 16, the command processor 500 may receive profiling data generated for each sub-task from the target device. The command processor 500 may re-organize the profiling data into one data to generate re-organized profiling data. For example, the command processor 500 may use the Queue time and pre-time of the Oth sub-task as the Queue time and pre-time of the re-organized profiling data, and use the time from the start time of the run-time of the 0th sub-task to the end time of the run-time of the (n-1)-th sub-task as the run-time of the re-organized profiling data. However, this is exemplary, and the command processor 500 may generate re-organized profiling data based on profiling data of sub-tasks in various ways, and the present disclosure is not limited thereto.

FIG. 17 is a diagram for explaining a method of monitoring two devices performing data transmission by a command processor according to embodiments of the present disclosure.

Internal devices of the Neural Processing SoC 10 may transmit and receive data to and from each other. In FIG. 17, a case where device A transmits data to device B and device B receives the data is illustrated. Device A and device B are assumed to use synchronized clock domains.

Referring to FIG. 17, due to communication delay, the point in time when device A finishes transmitting data and the point in time when device B receives the data sent by device A may not match. The reception time of data may be the time when device B receives the SYNC signal transmitted by device A.

The command processor 500 may generate integrated re-organized profiling data for data transmission operation of device A and device B by additionally considering communication delay time and the like together with profiling data of device A and profiling data of device B.

In addition to the above-described embodiments, monitoring commands for various events may be received. The command processor 500 according to embodiments of the present disclosure may intervene in the monitoring process to generate re-organized profiling data in an optimized manner and provide it to the CPU 20.

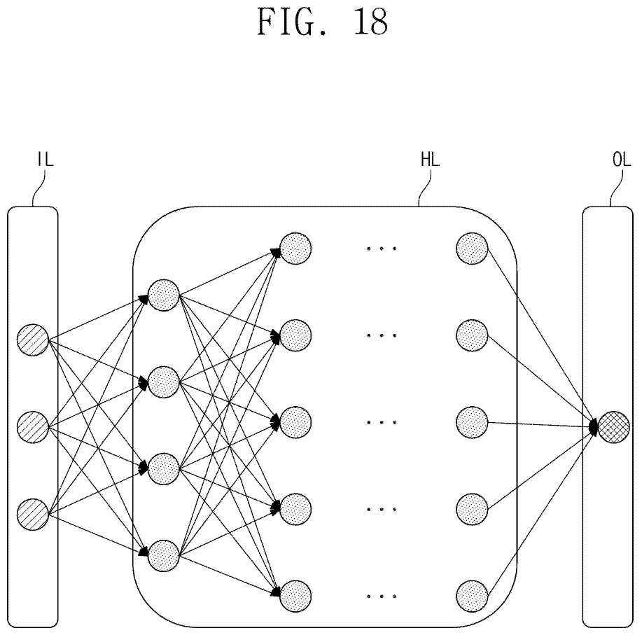

FIG. 18 is a diagram for explaining a deep learning operation performed by a neural processing system according to embodiments of the present disclosure.

Referring to FIG. 18, an artificial neural network model may have a multilayer perceptron structure. The artificial neural network model may include an Input Layer (IL), one or more Hidden Layers (HL), and an Output Layer (OL).

The artificial neural network model is an example of a deep learning-based machine learning model and may be implemented based on artificial neural network technology utilized in machine learning and cognitive science. The artificial neural network model is a form of deep neural network and may include a plurality of hidden layers, and may be optimized to automatically learn features from large-scale data. The artificial neural network model may include a statistical learning algorithm designed by imitating the structure of a biological neural network or a structure executing the algorithm.

The input layer (IL) may be composed of a plurality of input neurons. Input neurons of the input layer (IL) may receive data from the outside and transmit it to the hidden layer (HL). Data received from the outside may be provided in various forms such as images, text, and voice according to deep learning applications, and the present disclosure is not limited thereto.

The hidden layer (HL) may analyze data transmitted from the input layer (IL) in depth to extract important patterns and features. The artificial neural network model may include one or more hidden layers. Neurons in each hidden layer (HL) perform non-linear transformation using learned weights and activation functions, and may transmit this to the next layer. Connections between neurons in the hidden layer (HL) are learned through weight adjustment of synapses, and weights may be gradually optimized during the learning process.

The output layer (OL) may generate a final output based on data processed in the hidden layer (HL). Although the output layer (OL) is illustrated as being composed of a single neuron in FIG. 18, the neuron of the output layer (OL) may be one or more, and the present disclosure is not limited thereto. The output layer (OL) may calculate a prediction result based on signals received from the hidden layer (HL).

The artificial neural network model may be trained through supervised learning or unsupervised learning, which is one of deep learning training methods. In supervised learning, label data is used so that the model learns optimal weights, and in unsupervised learning, inherent patterns of data can be learned by itself. Also, a reinforcement learning method may be applied.

The neural processing system may generate training data of the artificial neural network model through simulation. In this process, input variables and output variables of the input layer (IL) and the output layer (OL) are matched, and weights connected to the hidden layer (HL) are adjusted to learn to derive optimal output. Also, in the learning process, hidden characteristics of input variables may be identified, and weights may be adjusted to minimize output errors. Through this process, the neural processing system can improve the performance of the artificial neural network model.

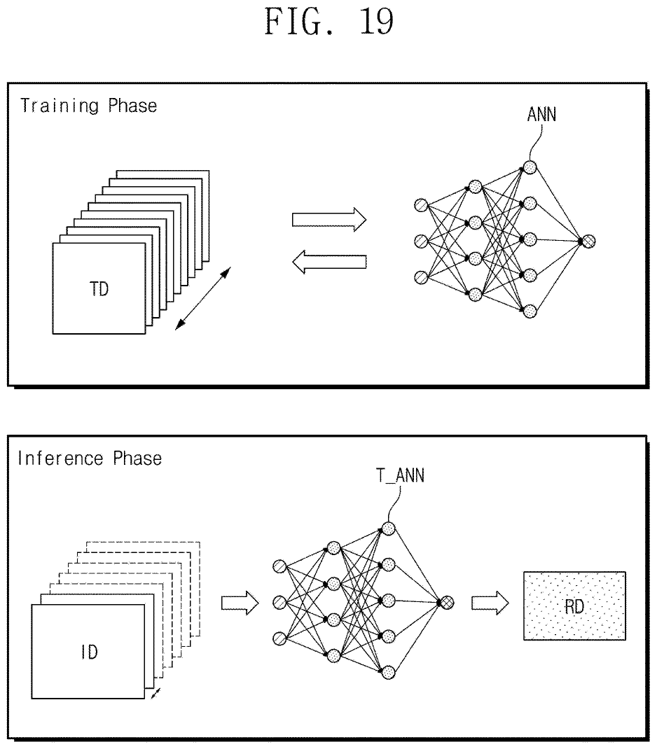

FIG. 19 is a diagram for explaining training and inference operations of an artificial neural network in a neural processing system according to embodiments of the present invention.

Referring to FIG. 19, in a training phase, a large amount of training data (TD) may be input to an Artificial Neural Network (ANN), and a forwarding and backwarding process in which weights and biases of the artificial neural network are repeatedly adjusted may be performed. Through this process, the performance of the ANN model gradually improves, and the optimized model may be updated to a trained artificial neural network model (T_ANN).

In an inference phase, new input data (ID) may be provided to the trained artificial neural network model (T_ANN). The input data (ID) may be smaller than the amount of training data (TD). The trained artificial neural network model (T_ANN) may derive result data (RD) for the input data (ID) based on the learned weights and biases. The result data (RD) may vary depending on the characteristics of the training data (TD) used in the training step and the accuracy of the trained model.

In the flowcharts according to the present disclosure, each step of the method or algorithm has been described in a sequential order, but each step can be performed not only sequentially but also in an arbitrarily combined order. The description regarding the flowcharts of the present disclosure does not exclude the addition, modification, or deletion of at least some steps in the method or algorithm. In embodiments of the present disclosure, at least some steps can be performed in parallel or repeatedly.

In embodiments of the present disclosure, components expressed as ‘part’, ‘~unit’, ‘~block’, ‘~module’, ‘~component’, etc., can be implemented as hardware that performs specific functions. Such hardware may include, for example, a circuit that performs operations or circuitry which is a set of interconnected circuits to perform complex functions. Here, ‘part’, ‘~unit’, ‘~block’, ‘~module’, ‘~component’, etc. perform specific functions and are not limited to software or hardware, and can be used to encompass data, components of software or hardware, or combinations thereof. In addition, the structures, methods, operations, processes, algorithms, etc., according to various embodiments of the present disclosure can be implemented through various means such as hardware, firmware, software, or combinations thereof.

Various embodiments of the present disclosure can be implemented as software recorded on a machine-readable recording medium. The software may be software for implementing various embodiments of the present disclosure described above. The software can be inferred from various embodiments of the present disclosure by programmers in the technical field to which the present disclosure belongs. For example, the software can be machine-readable instructions (e.g., code or code segments) or programs. A machine is a device capable of operating according to instructions called from a recording medium, and may be, for example, a computer. In one embodiment, the machine may be an electronic device according to embodiments of the present disclosure. In one embodiment, a processor of the machine can execute the called instructions, causing components of the machine to perform functions corresponding to the instructions. In one embodiment, the processor may be a processor of an electronic device according to embodiments of the present disclosure. A recording medium may refer to any kind of recording medium that stores data and can be read by a machine. A recording medium may include, for example, ROM, RAM, CD-ROM, magnetic tape, floppy disk, optical data storage device, etc. In one embodiment, the recording medium may be a memory. In one embodiment, the recording medium may be implemented in a distributed form, such as on computer systems connected by a network. Software can be stored and executed in a distributed manner on the computer systems or the like. The recording medium can be a non-transitory computer-readable recording medium. The non-transitory computer-readable recording medium refers to a tangible medium regardless of whether data is stored permanently or temporarily, and does not include temporarily propagating signals.

As described above, those skilled in the art to which the present disclosure pertains will recognize that the present disclosure can be implemented in various forms without changing its technical principles or essential features. Therefore, it should be understood that the above embodiments are illustrative and do not limit the scope of the present disclosure. The scope of the present disclosure is defined by the claims below rather than by the detailed description, and all modifications or variations based on the meaning and scope of the claims and equivalent concepts thereof should be construed as being included within the scope of the present disclosure.

The features and advantages described herein are merely illustrative, and many additional features and advantages will become apparent to those skilled in the art by referring to the drawings, specification, and claims. In addition, it should be noted that the language used in this specification has been chosen for readability and explanation, and is not necessarily chosen for the purpose of limiting the subject matter of the present disclosure.

The descriptions of the above embodiments are provided for illustrative purposes and are not intended to limit the scope of the present disclosure in precise form. Those skilled in the art will understand that various modifications and variations are possible through the disclosure of the present disclosure.

Therefore, the scope of the present disclosure is not limited by the detailed description, but is defined by the claims herein. Accordingly, the embodiments of the present disclosure are illustrative and do not limit the scope of the present disclosure as set forth in the claims below.

1. A Neural Processing System on a Chip (SoC), comprising:
a memory;
a performance monitoring unit configured to monitor an operation of a target device to generate profiling data, and store the profiling data in a first memory space of the memory; and
a command processor configured to read the profiling data from the first memory space of the memory, re-organize the read profiling data to generate re-organized profiling data, and store the re-organized profiling data in a second memory space of the memory.

2. The Neural Processing SoC of claim 1, wherein the command processor is configured to determine a target device to be monitored among a plurality of devices based on a common Performance Monitoring Unit (PMU) query description provided from a host.

3. The Neural Processing SoC of claim 2, wherein the command processor is configured to activate a performance monitoring unit of the target device to be monitored.

4. The Neural Processing SoC of claim 1, wherein the command processor is configured to:
parse a common PMU query description provided from a host;
predict a size of the profiling data based on the parsed common PMU query description; and
pre-allocate the first memory space based on the predicted size of the data.

5. The Neural Processing SoC of claim 1, wherein the command processor is configured to initialize the profiling data stored in the first memory space after storing the re-organized profiling data in the second memory space.

6. The Neural Processing SoC of claim 1, wherein the performance monitoring unit is configured to generate the profiling data whenever one inference operation is finished, and wherein the command processor is configured to re-organize the generated profiling data to generate the re-organized profiling data whenever the one inference operation is finished.

7. The Neural Processing SoC of claim 1, wherein the command processor is configured to:
receive, from a host, a command of one or more first command IDs and a command of a second command ID subsequent to the one or more first command IDs;
parse a common PMU query description provided from the host;
determine a size of the re-organized profiling data to be generated for each target device type based on the parsed common PMU query description;
calculate a size of the re-organized profiling data to be generated according to the command of the one or more first command IDs based on the size of the re-organized profiling data to be generated for each target device type;
generate a data offset for the second command ID based on the calculated size of the data;
generate a data offset table including the data offset for the second command ID; and
find re-organized profiling data corresponding to the second command ID in the second memory space based on the data offset table.

8. The Neural Processing SoC of claim 1, wherein the profiling data includes a command ID and timestamps of a plurality of events that sequentially occurred in the target device according to a command of the command ID, and
wherein the command processor is configured to generate the re-organized profiling data by:
removing the command ID from the profiling data;
recording difference values between the timestamps of the plurality of events; and
converting a timestamp of an event, among the plurality of events, at which the operation of the target device according to the command of the command ID is finished, from a clock domain of the target device to a clock domain of the command processor, and recording the converted timestamp.

9. The Neural Processing SoC of claim 8, wherein the plurality of events include a Queue-in and a Queue-out of the command of the command ID, and a task start and a task completion according to the command, and
wherein the recording the difference values between the timestamps of the plurality of events includes:
recording a difference value between timestamps of the Queue-out and Queue-in as a Queue time;
recording a difference value between timestamps of the task start and the Queue-out as a pre-time; and
recording a difference value between timestamps of the task completion and the task start as a run-time.

10. A Neural Processing SoC, comprising:
a memory;
a first performance monitoring unit configured to monitor an activity of a first neural core to generate first profiling data, and store the first profiling data in a first memory space of the memory;
a second performance monitoring unit configured to monitor an activity of a second neural core to generate second profiling data, and store the second profiling data in a second memory space of the memory; and
a command processor configured to read the first profiling data and the second profiling data from the first memory space and the second memory space of the memory, re-organize the read first profiling data and the read second profiling data to generate re-organized profiling data, and store the re-organized profiling data in a third memory space of the memory.

11. The Neural Processing SoC of claim 10, wherein the command processor generates re-organized profiling data by re-organizing the first profiling data and the second profiling data in a selected manner according to characteristics of operations executed by the first neural core and the second neural core.

12. The Neural Processing SoC of claim 11, wherein the command processor is configured to generate the re-organized profiling data based on an average value of a run-time of the first neural core and a run-time of the second neural core, in a case where the first neural core and the second neural core perform evenly distributed operations.

13. The Neural Processing SoC of claim 11, wherein the command processor is configured to generate the re-organized profiling data based on a run-time of the first neural core, in a case where the first neural core performs operations intensively.

14. The Neural Processing SoC of claim 11,
wherein the first profiling data includes a queue time, a pre-time, and a run-time related to the activity of the first neural core, and the second profiling data includes a queue time, a pre-time, and a run-time related to the activity of the second neural core,
wherein the command processor is configured to:
calculate time differences of the queue time, the pre-time, and the run-time of the second profiling data of the second neural core with respect to the queue time, the pre-time, and the run-time of the first profiling data of the first neural core; and
generate the re-organized profiling data based on the time differences.

15. A performance monitoring method of a Neural Processing SoC performed by a command processor of the Neural Processing SoC, the method comprising:
receiving a common PMU query description from a host;
determining a target device to be monitored by parsing the common PMU query description;
activating a performance monitoring unit for monitoring an activity of the target device;
storing profiling data generated by the performance monitoring unit in a first memory space of a memory of the Neural Processing SoC; and
reading the profiling data from the first memory space of the memory, generating re-organized profiling data based on the read profiling data, and storing the re-organized profiling data in a second memory space of the memory.

16. The performance monitoring method of claim 15, further comprising:
initializing the first memory space of a memory in which the profiling data generated by the performance monitoring unit is stored.
